(19) United States
(12) Patent Application Publication
(10) Pub. No.: US 2005/0202867 A1
(43) Pub. Date: Sep. 15, 2005

(54) Interactive display device

(75) Inventor: Ronald S. Cok, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/797,683

(22) Filed: Mar. 9, 2004

(51) Int. Cl. A63F 13/00

(52) U.S. Cl. 463/30

(57) ABSTRACT

Interactive display devices, display systems, and methods for operating the same are provided. The interactive display device has a display, a non-volatile memory having interaction data and image content depicting a character stored therein and a communication circuit adapted to transmit interaction data to another interactive display device and to receive interaction data from said other interactive display device. A display controller is adapted to determine modified interaction data based at least in part upon interaction data, to determine a character image based at least in part upon the modified interaction data and the stored image content and to cause of the display to present the character image. The display controller is further adapted to store modified interaction data in the non-volatile memory.

### FIELD OF THE INVENTION

This invention relates generally to a display device and, more particularly, to interactive display devices having pre-defined content.

### BACKGROUND OF THE INVENTION

Fantasy role-playing games are popular group activities. For example, board games have been used for many years to entertain players. Fantasy games using exchangeable cards have become popular in recent years. In these games, players typically collect a variety of cards depicting fantasy characters. The cards are carried by players and, when players meet, the cards are traded, exchanged, or acquired. Exchanges can occur by mutual consent or through the application of game rules governing allowed interactions between the characters. These cards are typically printed with pictures of characters and rules. Hence, their visual entertainment value is limited.

More complex interactive playing systems are known. For example, U.S. Pat. No. 6,634,949 B1 entitled “Multi-Media Interactive Play System” issued on Oct. 21, 2003 describes a multi-media interactive play system having a number of play elements situated in a variety of play environments or play media. The play elements are linked to a common record of participant performance, progress, character attributes, etc. The participant's performance in the play elements determines the play elements to which the participant may proceed as well as the play parameters of the play element in which the participant is currently involved. The play elements are thus interlinked to define a sequence or path network along which the participant advances. By advancing through the play elements the participant carries out a plot, story, theme, etc. that attaches a significance to the successful completion of a given play element or elements. Also disclosed is a variety of play elements suitable for use in the system, an example of a plot or theme that may be carried out by the system, and a send/receive radio frequency network that may be used to track play participants in a play center. However, such a system is extremely complex to implement, is expensive, and does not conform to rules for more common card-based games currently popular with children and young adults. Importantly, such a system typically does not support the collection aspects of currently popular games.

A single element entertainment device commonly known as the Tamagotchi was introduced in Japan by the Bandia Corporation in 1997. The Tamagotchi device is a key-chain computer game. In an initial iteration of this device, the game starts when a virtual egg on a display screen hatches and a virtual chicken is born. The owner then uses a user interface to effectively raise the chicken by performing activities such as feeding, cleaning up after it, and playing with it. Like a real pet, constant daily interaction is necessary to ensure proper growth and development. A failure to provide such interaction has consequences including, in extreme cases, the virtual death of the virtual chicken. While popular in its genre, such Tamagotchi games lack the competitive interaction that is popular in the card based games and further the form factor and the constant interaction required by such devices typically prevents users from maintaining large collections of such devices.

A large variety of other more conventional programmable video game devices are well known. For example, U.S. Pat. No. 6,544,126 B2 entitled “Portable Game Machine With Download Capability” issued Apr. 8, 2003 describes a portable handheld game machine that includes a capability to download and execute code from a source such as another game machine. However, such games are still quite large, typically limited to one or two players, and are relatively expensive and complex. Further, such game machines typically do not support collection aspects of popular card based games.

Thus, there remains a need for an interactive display device and system that permit a user to execute interactive transactions with the holders of other devices but that has a cost structure and form factor that facilitates storage of collections of such display devices.

### SUMMARY OF THE INVENTION

In a first aspect of the invention, an interactive display device is provided. The interactive display device has a display, a non-volatile memory having interaction data and image content depicting a character stored therein and a communication circuit adapted to transmit interaction data to another interactive display device and to receive interaction data from said other interactive display device. A display controller is adapted to determine modified interaction data based at least in part upon received interaction data, to determine a character image based at least in part upon the modified interaction data and the stored image content and to cause the display to present the character image. The display controller is further adapted to store modified interaction data in the non-volatile memory.

In another aspect of the invention, an interactive display system is provided. The interactive display system has a plurality of interactive display devices, each interactive display device having at least a display capable of forming images and non-volatile memory having character data stored therein. At least one source of character images and at least one source of character interaction data are provided. A communication circuit is adapted to exchange character interaction data between the plurality of interactive display devices. A display controller is adapted to determine modified interaction data for each of the interactive display devices to select at least one of the character images in the source of character images for presentation on each interactive display device based upon the modified interaction data determined for that interactive display device and to cause the character image selected for each interactive display device to be presented on the display associated with that interactive display device.

In still another aspect of the invention, a method is provided for operating an interactive display device having interaction data stored therein. In accordance with the method, another interactive display device having interaction data stored therein is detected. The interaction data from the other interactive display device is received. Modified interaction data is determined based at least in part upon interaction data received from the other interactive display device. A character image is determined based at least in part upon the modified interaction data and the character image is presented using the display device. The modified interaction data is stored in the interactive display device.

### ADVANTAGES

The interactive display devices, systems and methods of the present invention are advantageous in that they provides a low-cost, entertaining, and interactive structure enabling interactive games and social interactions between combinations of participants.

### BRIEF DESCRIPTION OF THE DRAWINGS

FIG. 1 is a schematic diagram of an interactive display according to an embodiment of the present invention;

FIG. 2 is a schematic diagram showing one embodiment of an interactive display having an efficient component arrangement;

FIG. 3 illustrates one example of a pair of interactive display devices used in combination;

FIG. 4 is an illustration of another embodiment of an interactive display system in accordance with the present invention;

FIG. 5a and 5b illustrate a memory map depicting, generally, one arrangement of interaction data stored in a memory of interactive display devices;

FIG. 6 is a flow diagram illustrating one embodiment of a method for executing interactive games using the interactive displays;

FIG. 7a and 7b illustrates what is presented on interactive display devices before an interaction;

FIG. 8a and 8b illustrates what is presented on interactive display devices after a first interaction; and

FIG. 9a and 9b illustrates what is presented on interactive display devices after a second interaction.

### DETAILED DESCRIPTION OF THE INVENTION

In accordance with various aspects of the present invention, an interactive display and interactive display system suitable for use in interactive activities such as gaming, music creation, and other forms of social interaction are provided.

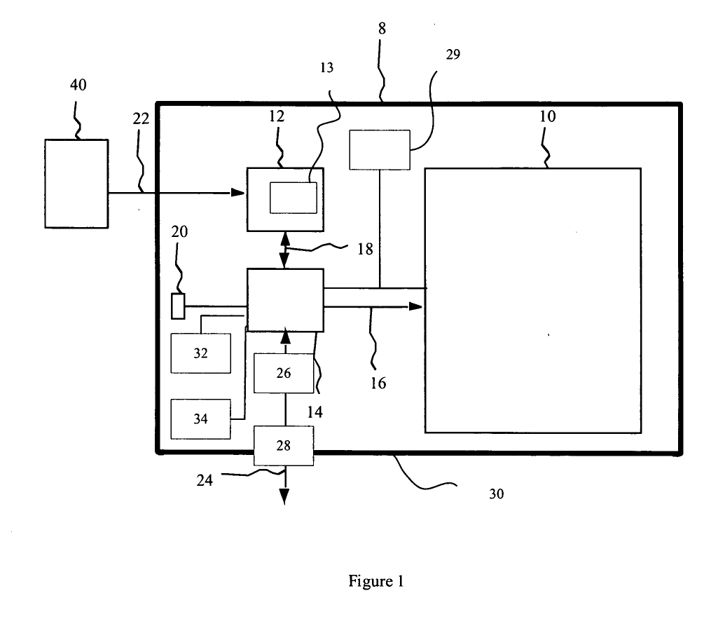

Referring to FIG. 1, one embodiment of an interactive display 8 according to the invention is shown. In this embodiment, interactive display device 8 has a display 10, a non-volatile memory 12, a switch 20 for turning the device on or off, and a display controller 14 for reading the non-volatile memory 12 and displaying image content on display 10 based upon data obtained from non-volatile memory 12. The embodiment of display controller 14 shown in FIG. 1, includes a display interface 16 to display 10 and a memory interface 18 to non-volatile memory 12. The display controller 14 includes a communication circuit 26 for exchanging data with a similar interactive display device 8. Non-volatile memory 12 can include multiple components some of which can include volatile read-write memory (e.g. RAM) along with non-volatile memories, such as a read-only memory (e.g. ROM), or a non-volatile read-write memory (e.g. Flash Memory). Such multiple components can comprise separate structures or can be manufactured as an integrated circuit.

As will be described in greater detail below, at least a portion of display memory 12 can comprise a locking memory 13. Locking memory 13 can be a memory that is of a type will restrict the ability of a user of interactive display device 8 to modify the data stored therein. In one embodiment, locking memory 13 comprises a conventional non-volatile programmable read-only memory or a write-once memory. In this embodiment, data can be written to the programmable read-only memory or to the write-once memory but, once written, such data cannot be erased, deleted or modified. In this way, the read-only memory provides a reliable record of data stored therein.

In another embodiment, locking memory 13 comprises a non-volatile read-write memory having a memory interface 18 that permits data to be read or written only where appropriate authorizations or codes are supplied to the write-once memory. In this embodiment, data written to locking memory 13 can be associated with interactive display system 8 in a manner that cannot be modified without appropriate authorizations.

In still another embodiment, locking memory 13 can comprise a conventional non-volatile read-write memory having data stored therein in an encoded or encrypted fashion that is readable by display controller 14, but that is difficult for a conventional user of interactive display device 8 to understand or reprogram properly. Various well-known encoding or encryption schemes can be used for this purpose.

Display controller 14 can be a programmable display controller such as a microprocessor, microcontroller or programmable analog device. Alternatively display controller 14 can be of a type that is not programmable and in this alternative can include a memory interface and display driver. Such a non-programmable embodiment of display controller 14 can be implemented for example with a state machine or hard-wired logic circuit. Such an alternative construction provides a low-cost and low-power display controller 14 that can perform the functions described herein.

An external interface 22 is optionally provided. In the embodiment shown in FIG. 1, external interface 22 is accessible to external circuitry 40. When interface 22 is connected to external circuitry 40, for example, by way of a Universal Serial Bus connector, external interface 22 can be used to transmit and receive image content and interaction data from external circuitry 40 and stores this image content in the non-volatile memory 12. Alternative embodiments of the external interface can be provided, for example, by a networked interface to a computer network or the Internet. External interface 22 can be used to set up and program non-volatile memory 12 with image content and interaction data and for programming display controller 14.

Communication circuit 26 is provided for enabling communication between interactive display device 8 and other interactive display devices. Communication Circuit 26 can take a variety of forms, for example it can comprise any of a transmitter, receiver, transceiver, transcoder, or any other device adapted to encode and decode data for exchange during communication with other devices and, where appropriate, a communication access port 28 that provides access to areas outside of a body 30 of interactive display device 8 to facilitate such communication. Communication circuit 26 and access port 28 are co-designed to facilitate communications. Communication circuit 26 can be implemented in a variety of ways, including wirelessly, for example using radio frequency, optical or other known wireless communication circuits and systems to establish a wireless communication path. Examples of such wireless communication systems include but are and not limited to circuits and systems that communicate in ways that that conform to wireless communication standards such as the so-called “Wi-Fi” and so-called “Bluetooth” standards established and described at Institute of Electrical and Electronic Engineers standards 802.11a and 802.11b. Alternatively communication circuit 26 can be adapted to communicate using infrared technology using protocols established by the infrared data association (IrDA). Such protocols include, but are not limited to the serial infrared protocol (SIR) and other protocols developed by the IrDA.

In such wireless embodiments, access port 28 provides, for example, an antenna for use in radio frequency communication, or light transmitting and sensing areas adapted to optically exchange data, such as an infrared or other optical interface system known in the art.

In other embodiments, communication circuit 26 can be adapted for communication with another interactive display device using a direct electrical or optical path between access port 28 of the interactive display device 8 and another interactive display device. In such embodiments access port 28 can comprise, for example, a serial or parallel port, or a networked interface to a computer network or the Internet. One example embodiment of a communication circuit of this type is a communication circuit 26 that is adapted to enable communication using hardware and protocols that are consistent with the EIA/TIA-232-E standard entitled “Interface Between Data Terminal Equipment and Data Circuit-Termination Equipment Employing Serial Binary Data Interchange” prepared by the Electronic Industry Association and the Telecommunications Industry Association. Other example embodiments of a communication circuit of this type include circuits and systems that conform with the standards set for the universal serial bus standard, and the IEEE 1394 (so-called “Firewire”) standard. Communication circuit 26 can also comprise circuits and systems that comply with other standards or that comply with proprietary standards.

In still another embodiment, communication circuit 26 can be adapted to exchange data with a portable memory device such as a removable memory card that can be held by access port 28 of interactive display device 8 and moved to an access port 28 of another interactive display device so that data can be exchanged using the removable memory card as an intermediary.

In an alternative embodiment, a direct link can be established using optional external interface 22 in addition to or in place of access port 28.

In the embodiment shown in FIG. 1, interactive display device 8 comprises a power cell 29, for example a battery, that provides power to display 10, non-volatile memory 12, display controller 14, display interface 16, memory interface 18, switch 20 and/or external interface 22, and communication interface 24. In certain embodiments, power can be supplied to these components of interactive display device 8 by way of external interface 22 and/or access port 28.

In the embodiment of FIG. 1, interactive display device 8 also comprises an optional user input system 32 to enable a user to provide input to display controller 14 that display controller 14 can use in operating display device 8. For example, display controller 14 can determine interaction data based upon user input as will be described in greater detail below. User input system 32 can comprise, for example, a touch screen input, a touch pad input, a 4-way switch, a 5-way switch, a 6-way switch, an 8-way switch, or any other multi-way switch structure, a stylus system, a trackball system, a joystick system, a voice recognition system, a gesture recognition system or other such systems.

An optional audio system 34 can be incorporated into interactive display device 8 to convert an audio signals stored in non-volatile memory 12 into an audible form and, optionally, to record audio signals provided by a user. Audio signals can be included as part of interaction data as will be described in greater detail below. Efficient, low cost, audio playback methods are well-known and enabling devices are commercially available.

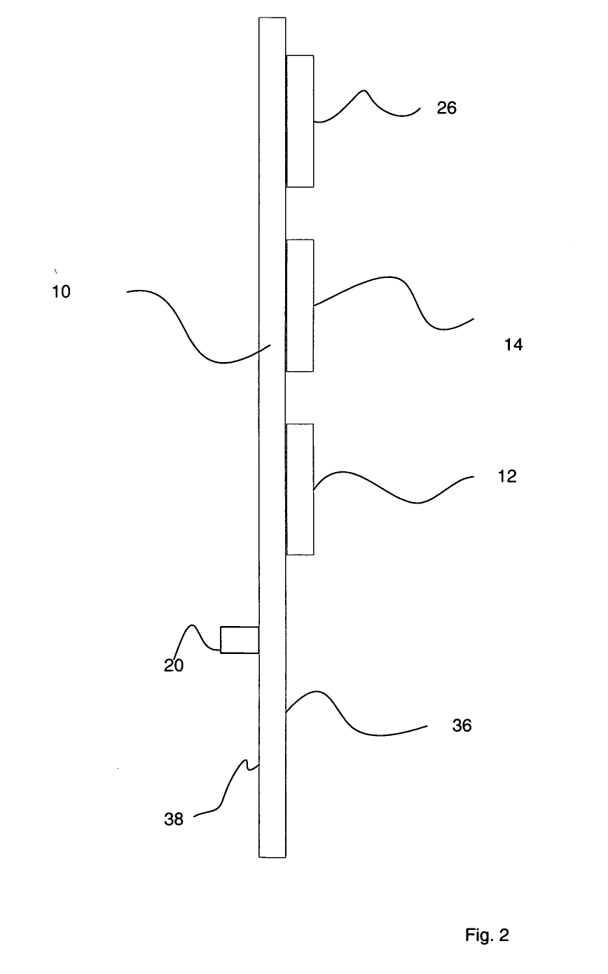

It is useful to minimize the thickness of interactive display device 8 to mimic, as closely as possible, conventional printed communications for example, cards, photographic prints, paper media and the like. To this end, the components such as non-volatile memory 12, display controller 14, and switch 20 that are used in various embodiments of interactive display system 8 can be assembled on a back 36 or face 38 of display 10 as shown in the embodiment shown in FIG. 2. In particular, it may be useful to have non-volatile memory 12, display controller 14 and communication circuit 26 affixed to the back of the display 10 and switch 20 to be affixed to a face 38 of display 10 or otherwise positioned so that it can be conveniently actuated by a user of interactive display device 8. In this way, interactive display device 8 can take a form that is consistent with the form of a conventional collectable/trading card such as a baseball card, a football card, or the like, a collectable/trading/gaming card of the type that currently carries images of fanciful characters thereon, and/or other forms of collectable memorabilia. Interactive display device 8 can also be incorporated onto rigid or flexible and/or foldable substrates to provide a wide variety of items.

Display controller 14 and non-volatile memory 12 can be combined into a single integrated circuit and/or potted together, for example, using a protective resin to provide a small, low-cost circuit. Any protective material applied to the circuitry can be applied after the image content and interaction data is written to the non-volatile memory 12.

In operation, a mass-produced set of image sequences and interaction data can be written into the non-volatile memory 12 before assembly of interactive display device 8 or after assembly using external circuitry 40. Alternatively, a purchaser of interactive display device 8 can personalize the image content and/or interaction data, for example by transmitting personalization data through the external interface 22, or communication circuit 26. Such personalization data can include, for example, character names and character appearance, interaction information, audio, and video signals. Personalization data can also be entered using of user input system 32 of interactive display device 8. For example, during an initial set-up phase of operation of interactive display device 8, display controller 14 can require an operator to provide personalization data through user-input system 32. The external circuitry 40 can also provide additional power to interactive display device 8 during writing and may also charge power cell 29.

According to one embodiment of the present invention, a plurality of interactive display devices 8 are provided to a group of game players. Each interactive display device 8 has a character identity. Interaction data relevant to the character identity is stored in non-volatile memory 12. The character identity is defined in part by one or more images, an image sequence, or a stream of image information or any other form of video or graphic content relevant to the character and in part upon other interaction data that can be used by display controller 14 during various interactions, as will be described in greater detail below.

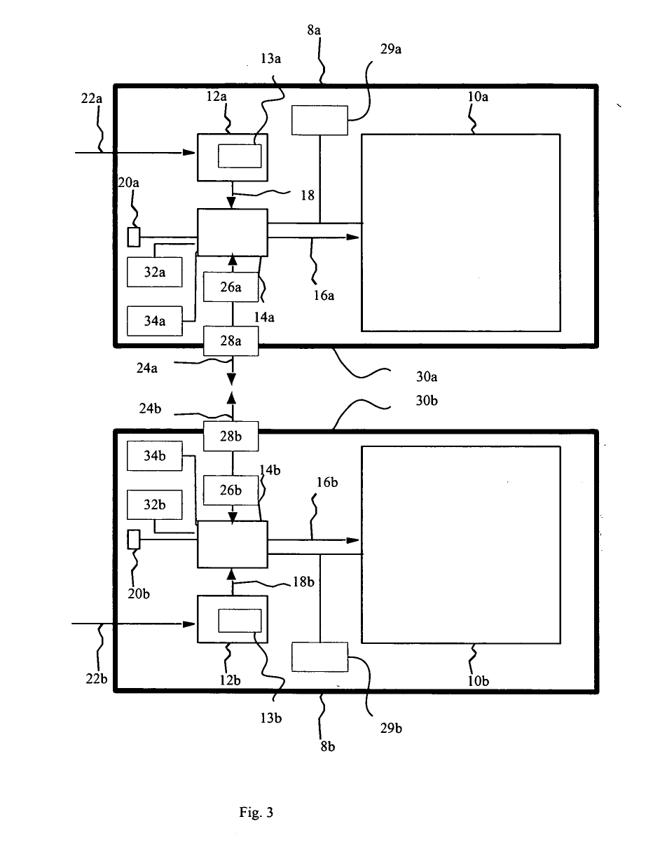

In operation, interactive display devices 8 are used in combination. As is shown in FIG. 3, this can be done by combining display device 8a in a paired relationship with another display device 8b. Each pair exchanges interaction data through communication circuits 26a and 26b . Interaction data can include, but is not limited to, character identification data, character attributes data, character status data, and image data. Display controllers 14a and 14b in interactive displays 8a and 8b will then determine modified interaction data based upon the interaction data received from the other interactive display device. Display controllers 14a and 14b will then use the modified interaction data and images or other graphic content stored in memory 12 to generate an entertaining image, images, or image sequence, and/or audio sequence representing the interaction of the characters on each of displays 10a and 10b. In this way, characters can be exchanged, characters can gain or lose attributes, points, status, power or other attributes relevant to the game or other interaction. The character interaction can be dependent on some degree of chance or on information supplied by the operator of interactive display devices 8a and 8b in response to questions or other opportunities for providing user input by way of user input systems 32a and 32b so that one operator may be lucky while another may be more knowledgeable, thereby influencing the nature of the interaction.

In any embodiment of interactive display device 8 having a locking memory 13, locking memory 13 can be used to store a protected record of information relevant to a character with which the interactive display device is associated. For example, locking memory 13 can be used to store data indicating an amount of character status. The character status can include thing such as remaining health or vitality which can be increased or decreased based on the nature or outcome of the interaction. By storing such information in the locking memory 13, the character associated with the card interactive display device is provided with a virtual life. When interactions occur that negatively impact a status associated with the character, information characterizing such interactions is recorded in the locking memory 13 so that, during future interactions, the nature and/or outcome of the interaction between the character associated with the interactive display devices 8a and 8b will be influenced by the status of the characters as they enter the interaction.

As interactive display devices 8a and 8b undergo a series of interactions, the status score associated with each of interactive display devices 8a and 8b can be reduced. When, for example, the status score for a character associated with display device 8a reaches a minimum threshold, display device 8a can cease to interact with interactive display device 8b or with other interactive display devices. In this way, a character associated interactive display device 8a can effectively be removed from a game until the status score is restored, such as by providing a new locking memory 13, recording restorative data in locking memory 13, by entering an authorization or code that will cause a memory controller for a rewritable embodiment of a locking memory 13 to allow editing of the status score, by recording a revised score in locking memory 13 using a proper encodement or encryption scheme, or by otherwise storing data in locking memory 13 that adjusts the status score. In this way, the restoration of status to a character can be blocked, limited or controlled as preferred by the dictates of the game. Further, restoration of vitality can be obtained by way of purchase.

Other modified interaction data can be stored in locking memory 13, such as a record of characters that had previously been interacted with, interaction data provided by other devices, a record of skills or capabilities obtained as a product of previous interactions and other such data.

Interactive display devices 8 having different characters can be vended by vending machines, kiosks and the like. Different interactive display devices can be selected by a purchaser, each having different attributes and that may be sold at different prices. Alternatively, groups of players may agree to establish a set of character and interaction data parameters and utilize a computer network and software to provide interaction data, such as images and other data relevant to the character such as a status score for their interactive display device 8. In certain embodiments, users can determine characters and interaction data for use in a game by way of agreement among players and can enter these agreed upon limitations by way of user interface 32. In other embodiments, characters and interaction data associated with those characters can be purchased for example, a user of interactive display device 8 associated with one character can purchase a particular character or a particular character status level or skill from a vendor, kiosk or on-line retailer.

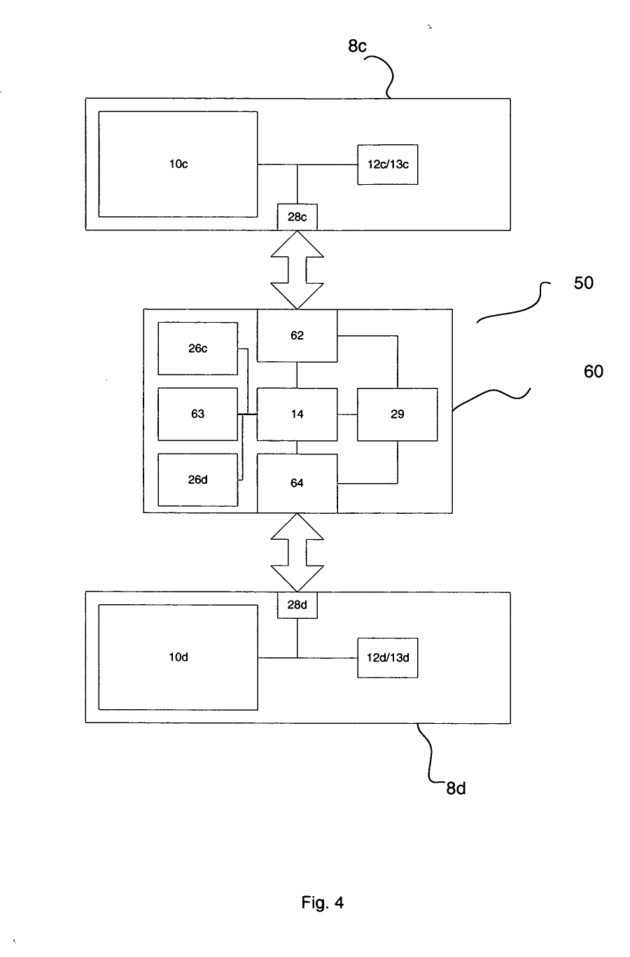

FIG. 4 shows yet another embodiment of the present invention. In this embodiment, an interactive display system 50 is provided having a plurality of interactive display devices 8c and 8d and an interface module 60 that joins interactive display devices 8c and 8d. In this embodiment, each interactive display device 8c and 8d incorporates respectively a display 10c and 10d, a memory 12c and 12d, and access ports 28c and 28d. Memories 12c and 12d store character information as described above and can comprise locking memories 13c and 13d. Interface module 60 comprises a display driver 14, and engagement ports 62 and 64 each adapted to engage an access port 28c and 28d respectively to establish a direct electrical connection for communication therebetween.

In the embodiment shown in FIG. 4, interface module 60 comprises a source of power 29 that is capable of supplying power to operate interface module 60 as well as displays 10a and 10b and memories 12c, 12d, 13c and 13d as necessary.

During operation, interactive display devices 8c and 8d are connected to interaction module 60 by attaching access port 28a to engagement port 62 and by attaching access port 28b to engagement port 64. Such engagement establishes a direct data path between displays 10, memories 12c, 12d, 13c and 13d, and display driver 14. Display driver 14 obtains interaction data from each of interactive display devices 8c and 8d using this data path. Upon receipt of such information, display driver 14 determines the nature of the interaction to occur between the interactive display devices 8c and 8d. Where appropriate, display driver 14 can then generate signals that cause either of display devices 8c or 8d to generate images or audio signals soliciting a user input. Such a user input can be made using user input systems 26c and 26d provided as a part of interaction module 60.

Based upon the obtained interaction data and the user inputs display controller 14 can determine modified interaction data for each interactive display device 8c and 8d. Display controller 14 can then determine modified image content for presentation on display devices 8c and 8d. In the embodiment that is shown in FIG. 4, display controller 14 obtains image information from each of memories 12a, and 12b based upon the interaction data and generates signals that cause each interactive display devices 8c and 8d to present an image that is appropriate for the modified interaction data. Accordingly, in this embodiment, an interactive display device 8c or 8d can be provided that has a small shape and is low cost yet preserves the interactive functionality by moving certain systems and circuits that add cost to an interactive display device to interface module 60.

In a further embodiment, each of memories 12c and 12d can hold only character identification data having information that identifies the character and provides interaction data for the character using the character identification data. Where this is done, interaction module 60 will be adapted to obtain character image information for each character. This can be done as shown in FIG. 4, by obtaining such information from a memory 63 with character image information and/or other information regarding the character stored therein. Memory 63 can be a component of interaction module 60 or it can be separate therefrom and joined thereto by way of a wired or wireless communication path. In one example of this type of the arrangement, the character identification data can comprise information that allows display driver 14 to obtain character image information from a memory 63 by way of a network such as the Internet. In this for example, the character identification data can comprise a World Wide Web address. Display driver 14 uses a World Wide Web address to obtain image information. Display driver 14 then uses the obtained image information to adjust the appearance of images presented on displays 10c or 10d as appropriate.

In still another embodiment, each of memories 12c and 12d can be adapted so that they contain only character identification data that uniquely identifies the characters associated with interactive display devices 8c and 8d respectively. In this embodiment, display driver 14 stores character image data and character interaction data in memory 63 so that such data can be recalled using the character identification data. Accordingly, in this embodiment, the amount of data to be stored in interactive display devices 8c and 8d is minimal, further reducing the cost of an interactive display device of this type.

It will also be appreciated that, in these embodiments, a display driver 14 and source of power is not provided for each interactive display device 8. Such an approach is possible where a non-volatile display 10 is used to present image information. It is characteristic of a non-volatile display 10, that it allows images to be electronically written and electronically rewritten to non-volatile display. However, once written, the written content maintains the appearance that is written thereon without requiring additional power input.

One popular embodiment of such a non-volatile display 10 is a bi-stable cholesteric display device. Such a non-volatile display 10 provides reflective picture elements that have at least two states and that can be transitioned from one state to at least one other state to form images. Non-volatile display 10 can comprise for example, a reflective passive-matrix display. Such reflective passive matrix displays can be employed because they do not require energy for light emission and are well-suited to low-cost control and manufacturing methods. One such display using bi-stable cholesteric materials is described in U.S. Pat. No. 5,437,811 entitled “Liquid Crystalline Light Modulating Device and Material” issued Aug. 1, 1995. Such displays can be made on flexible substrates and with low-cost roll-to-roll or continuous manufacturing methods thereby reducing cost and providing useful attributes in an interactive display application. Where such a nonvolatile display is used, interface module 60 can provide the necessary circuits and systems for writing images to the display 10. In this way, each interactive display device 8 can be made inexpensively and in a form factor that can be conveniently collected and stored in a manner that is consistent with conventional practices.

In other embodiments of the invention, display 10 can be implemented with a variety of flat-panel display technologies, including full-color organic light emitting diode (OLED) displays or liquid crystal displays (LCDs) and appropriate drivers and power sources can be supplied in interactive display devices that operate such display types so that they can present images as required by a user.

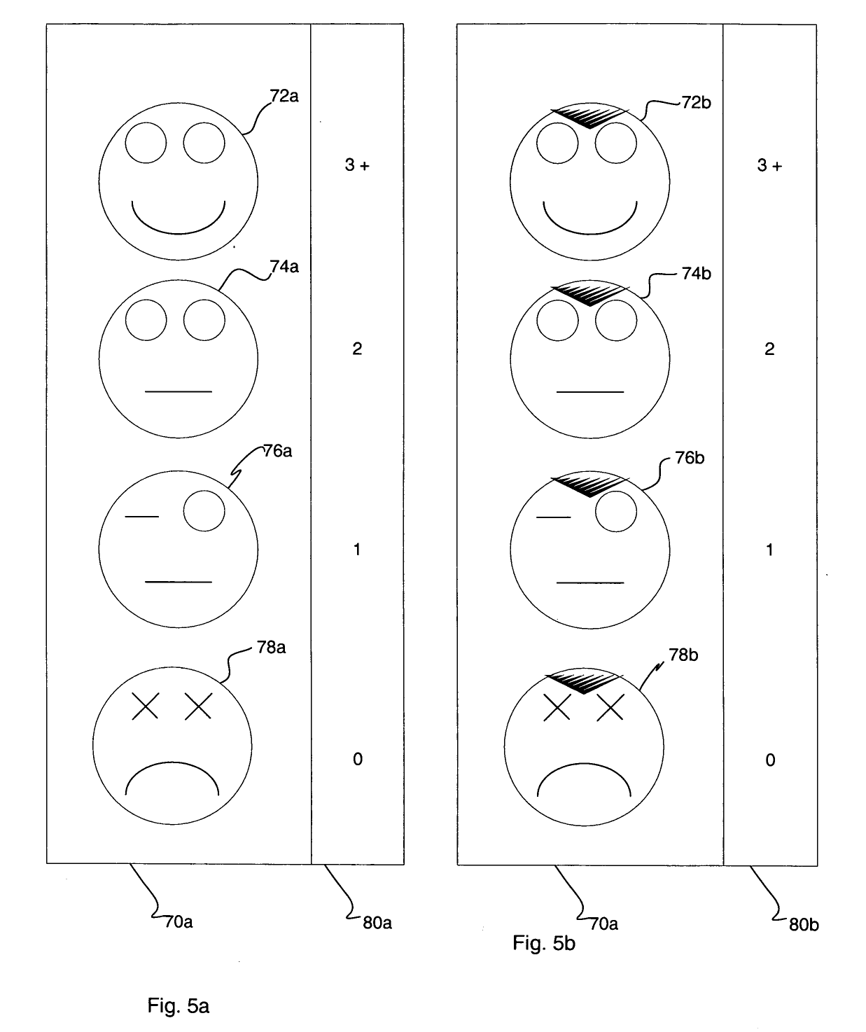

Turning now to FIGS. 5-7, an illustrative example of an interaction sequence for a pair of display devices is provided. For the purposes of this example, an interaction between display devices 8a and 8b as shown in FIG. 3 will be described. FIGS. 5a and 5b show an example of a memory map depicting, generally, one arrangement of interaction data 70a and 70b stored in non-volatile memories 12a and 12b of interactive display devices 8a and 8b. For the purposes of this example it will be assumed that, at the time that interactive display devices 8a and 8b are first provided, each non-volatile memory 12a and 12b has a set of character images 72a, 74a, 76a, 78a, and 72b, 74b, 76a and 78b respectively stored therein. Each image in each set of images depicts an image of a character having a different appearance that corresponds to one of a set of status scores 80a and 80b. Initially each character has a status score of 3 and therefore display controllers 14a and 14b cause the images 72a and 72b to be presented, respectively, on displays 10a and 10b.

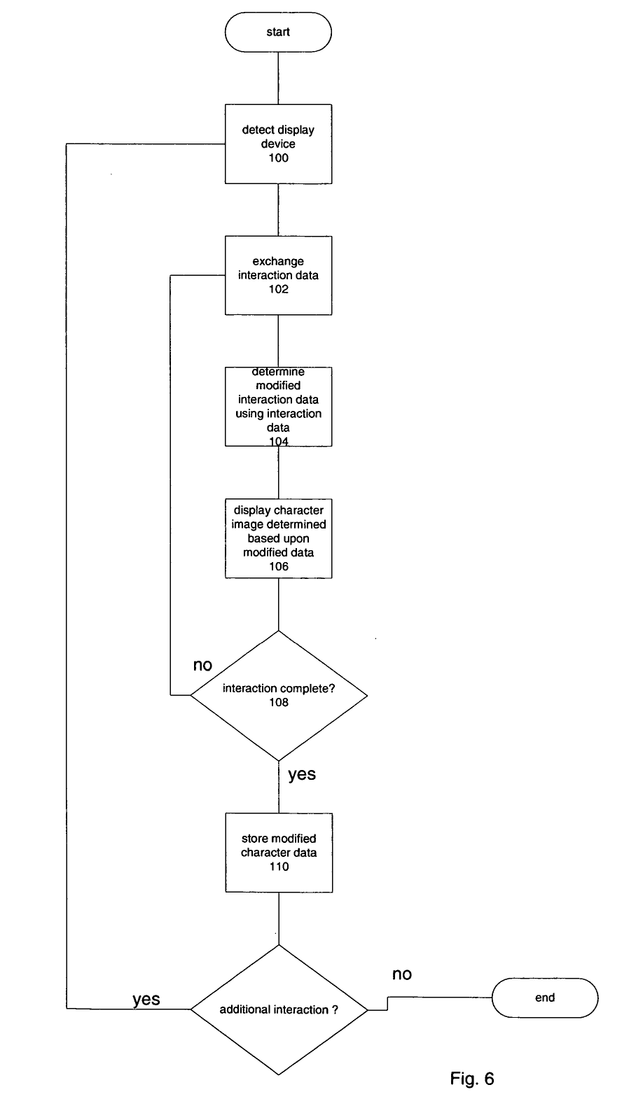

FIG. 6 is a flow diagram illustrating one embodiment of a method for a executing an interactive game using two interactive display devices such as interactive display devices 8a and 8b.

As is shown in FIG. 6, in a first step of the method each display device 8a and 8b detects the other interactive display device, devices 8b and 8a respectively (step 100). Such detection is typically performed, when a communication path is established between display devices 8a and 8b. As described above, such a communication path can be established using a wireless connection or wired connection or by using an intermediary such as a memory card, or by other conventional communication systems.

When the communication path between interactive display devices 8a and 8b is detected, display controllers 14a and 14b will exchange interaction data (step 110). As noted above, the interaction data can comprise any information that identifies a character, a character's status and other information about the character that is stored in a non-volatile memory 12 and/or locking memory 13 of an interactive display device with which the character is associated. The interaction data can comprise other information such as, in this example, information that defines a desired interaction. For example a user of interactive display device 8b can use user input system 32 to indicate that the user wants the character associated with interactive display device to interact with the character associated with interactive display device 8a in a particular manner. Such input can be used by display controller 14b and, optionally, can be conveyed to interactive display device 8a as a part of the interaction data. Similarly, display controller 14b will receive interaction data from interactive display device 8a.

Based upon the interaction data exchanged, display controllers 14a and 14b will determine modified interaction data (step 104). In this embodiment, this step is performed by determining a modified status score based upon the received interaction data. There are many ways in which this can be done. For example, the interaction data can define a type of interaction such as an attack mode for each interactive device and a defense mode for each interactive device. The attack mode selected for the character associated with interactive display device 8a can be for example a “kick high mode” while the defense mode is “block low mode” while the attack mode selected for the character associated with interactive display device 8b can be an “attack middle mode” while the defense mode is a “block high” mode. In such a situation, the status for the character associated with interactive display device 8a can be reduced by 2 levels because the character did not block the attack nor did the character's attack succeed, while the status for the character associated with interactive display device 8 be can remain at the same level because the character associated with interactive display device 8b blocked the selected attack. It will be appreciated that a wide variety of variations are possible.

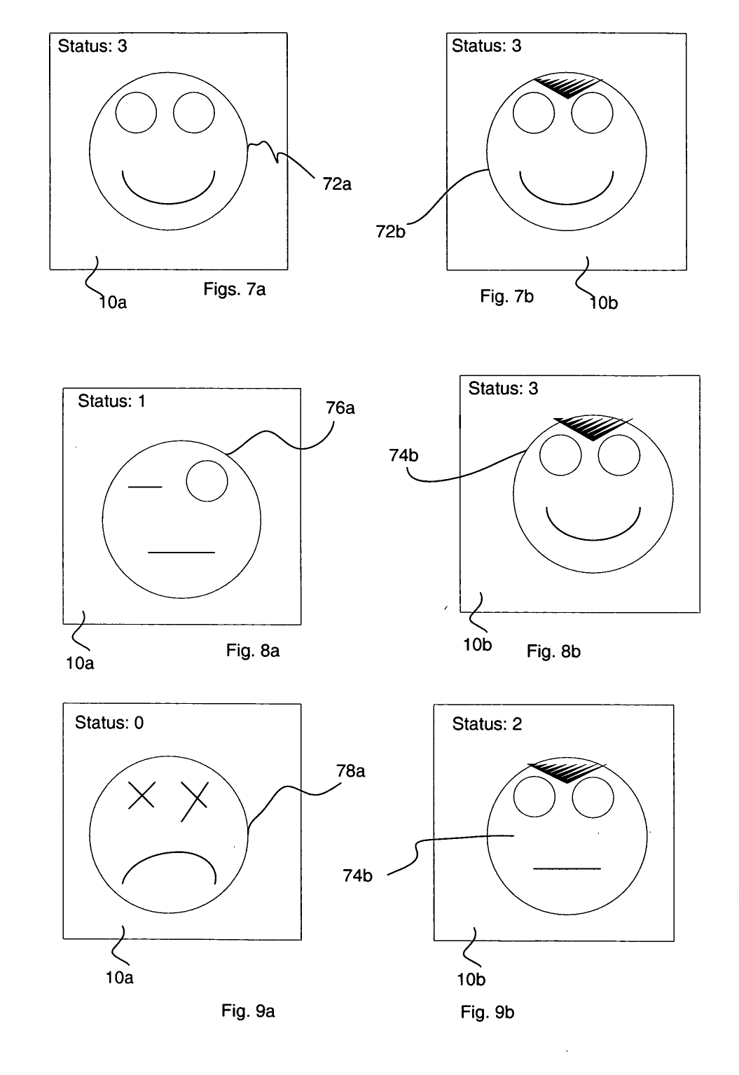

In this example, the revised status for each character associated with display devices 8a and 8b comprises the modified interaction data. This modified interaction data is then used to determine an image to be presented using displays 10a and 10b (step 106). In this embodiment, display controller 14a uses the revised status level to select image 76a from non-volatile memory 12a and causes this image to be presented on display 10a as is shown in FIG. 7a. Similarly, display controller 14b uses the revised status level determined for the character associated with display device 8b to obtain image 74b from non-volatile memory 12b and causes this image to be presented on display 10b as is shown in FIG. 7b.

Display controllers 14a and 14b then determine whether to engage in another round of interaction (step 108). There are a variety of ways in which this determination can be made. For example, where the connection between interactive display device 8a and interactive display device 8b remains for a period of time after the first round of interaction is complete, then it can be determined that there is a desire for another round of interaction. Alternatively, interactive display device controllers 14a and 14b can present an inquiry using displays 10a and 10b, or audio system 34a and 34b to solicit a user input as to whether an additional round of interaction is to occur. In still another embodiment, interactive display device controllers 14a and 14b can be adapted to continue interactions until one of the characters associated therewith reaches a 0 status level or some other minimum threshold.

For the purposes of this example, the latter embodiment is used. As the status for both of the characters is above the 0 level, another round of interaction is to occur, and the process returns to the steps of exchanging interaction data (step 102) and determining modified interaction data using the interaction data (step 104). If, in this example, as result of the second round of interaction, the status of each character in the interaction is reduced by one level, then the status level of the character associated with interactive display device 8a is reduced to the 0 level and the status level the character associated with interactive display 8a is reduced to the two level. Accordingly, as is shown in FIG. 9a where this occurs, display driver 14a obtains image 78a from non-volatile memory 12a and causes this image to be presented on display 10a (step 106). Similarly, as is shown in FIG. 9b display driver 14b obtains image 74b from non-volatile memory 12 and causes this image to be presented on display 10b (step 106). Such images continue to be presented until further modified status is determined for example as a result of reprogramming or subsequent interaction.

At this point, because the character associated with interactive display device 8a has a 0 status level, it can be determined that the interaction between interactive display device 8a and interactive display device 8b is complete (step 108). The process then moves to the step of storing modified interaction data (step 110). In this step, the status level associated with each character at the completion of the interaction cycle is recorded in non-volatile memories 12a and 12b respectively. In certain embodiments, the status level is recorded in a locking memory 13. Depending upon rules for the interactions involved, other information can be stored in non-volatile memory 12a and non-volatile memory 12b as a result of the interactions. For example, in selected games that are currently popular, each character is associated with a specific set of capabilities. In one embodiment of the invention, a set of capabilities can be associated with a character and when one character effectively reduces the status level of another character to 0, then the surviving character can absorb the capabilities of the reduced character. Such additional capabilities can be recorded in a non-volatile memory 12 and/or a locking memory 13. In this way, characters are created that have an evolving set of characteristics and capabilities and that become more valuable as they successfully interact other interactive display devices.

After the modified interaction data has been stored (step 110), at least one of the interactive display devices (e.g. interactive display device 8b) can search for additional interactive display devices to engage in further interactions (step 112)

The invention has been described in detail with particular reference to certain preferred embodiments thereof, but it will be understood that variations and modifications can be effected within the spirit and scope of the invention.

### Parts List

8 interactive display device
10 display
12a, b, c, d non-volatile memory
13a, b locking memory
14a, b, c, d display controller
16a, b display interface
18a, b memory interface
20a, b switch
22a, b external interface
24a, b communication circuit
26a, b communication transducer
28a, b access port
29a, b power cell
30 body
32a, b user input system
34a, b audio system
36 front of display
38 back of display
40 external circuitry
60 interface module
62 port
64 port
70a, b interaction data
72a, b-78a, b character images
80a, b status score
100 detect display device step
102 exchange interaction data step
104 determine modified interaction data step
106 display image step
108 interaction complete determine step
110 store modified interaction data step
112 additional interaction step

1. An interactive display device comprising:
a) a display;
b) a non-volatile memory having interaction data and image content depicting a character stored therein;
c) a communication circuit adapted to transmit interaction data to another interactive display device and to receive interaction data from said other interactive display device; and
d) a display controller adapted to determine modified interaction data based at least in part upon received interaction data, to determine a character image based at least in part upon the modified interaction data and the stored image content and to cause the display to present the character image;
e) wherein the display controller is further adapted to store the modified interaction data in the non-volatile memory.

2. The interactive display device of claim 1, wherein the image content depicting the character includes at least one group of image sequences.

3. The interactive display device of claim 1, wherein the image content depicting the character includes image content depicting character interactions.

4. The interactive display device of claim 1, wherein the communication circuit comprises a transducer for exchanging data using a wireless communication path.

5. The interactive display device of claim 1, wherein the communication circuit is adapted for communication by way of a physical communication path.

6. The interactive display device of claim 1, wherein the communication circuit is adapted to use a removable memory to exchange data with the other interactive display.

7. The interactive display device of claim 1, further comprising a user input system and wherein interaction data is entered using the user input system.

8. The interactive display device of claim 1, wherein the communication circuit is adapted to communicate with said other display device using network interaction.

9. The interactive display device of claim 1, wherein the interaction data includes at least one of character identification, character attributes, and character status.

10. The interactive display device of claim 1, wherein the modified interaction data includes at least one of modified character identification, modified character attributes, and modified character status.

11. The interactive display device of claim 1, further comprising a user input system having a transducer for converting a user input action into a signal that can be used by the display controller to determine personalization information.

12. The interactive display device of claim 11, wherein at least one of the character, images, and/or character attributes are personalized in accordance with the personalization data.

13. The interactive display device of claim 12, wherein the display controller is further adapted to cause the display to present questions relevant to a character and wherein answers to the questions are used to determine personalization data.

14. The interactive display device of claim 11, wherein the personalization data is used as part of the interaction data.

15. The interactive display device of claim 1, wherein the display is a flexible display.

16. The interactive display device of claim 1, wherein the display is the approximate size of a playing card.

17. The interactive display device of claim 1, wherein the display is a flat-panel display.

18. The interactive display device of claim 1, wherein any of the non-volatile memory, the display controller, and the communication circuit are mounted on the display.

19. The interactive display device of claim 1, wherein the display is an OLED display.

20. The interactive display device of claim 1, wherein the image content is at least one of a motion image sequence, a still image, a group of still images and a stream of image information.

21. The interactive display device of claim 1, further comprising an audio system to generate audio signals based upon audio content stored in the non-volatile memory and display controller.

22. The interactive display device of claim 1, wherein the interaction data further comprises audio content and wherein the display further comprises an audio system adapted to generate sounds based upon the audio content received by the display device.

23. The interactive display device of claim 1, wherein the display is a passive-matrix display.

24. The interactive display device of claim 1, wherein the display is a reflective display.

25. The interactive display device of claim 1, wherein the display uses bi-stable cholesteric materials to form images.

26. The interactive display device of claim 1, wherein the display is a color display.

27. The interactive display device of claim 1, wherein the display controller is a non-programmable state machine.

28. The interactive display device of claim 1, wherein the display controller comprises a non-programmable logic circuit.

29. An interactive display system comprising:
a plurality of interactive displays devices each interactive display device having at least:
a display capable of forming images and a non-volatile memory having character data stored therein;
at least one source of character images;
at least one source of interaction data;
a communication circuit adapted to exchange interaction data between the plurality of interactive display devices; and
a display controller adapted to determine modified interaction data for each of the plurality of display devices, to select at least one of the character images in the source of character images for presentation on each interactive display device based upon the modified interaction data determined for that interactive display device and to cause the character image selected for each interactive display device to be presented on the display associated with that interactive display device,
wherein the display controller further causes the modified interaction data to be stored in the non-volatile memory.

30. The display system of claim 29, wherein the communication circuit and display controller are located in an interface module that is separate from the display devices.

31. The display system of claim 30, wherein the display is a bi-stable display and wherein the display controller comprises a display driver for causing an image to be formed on the bi-stable display.

32. The display system of claim 29, wherein each display device has interaction data stored therein that associates the interactive display device with character images.

33. The interactive display system of claim 32, wherein the character images, and character interaction data are transmitted via a communication through a computer network and stored within the interactive display devices.

34. The interactive display system of claim 33, wherein the character images and interaction data are stored within the interactive display devices at manufacture and the interactive display devices are vended in a vending machine.

35. The interactive display system of claim 31, wherein the character associated with each interactive display device is selected by a purchaser.

36. The interactive display system of claim 29, a kiosk vends interactive display devices having different characters selected by a purchaser.

37. The interactive display system of claim 36, and wherein the kiosk vends interactive display devices with particular characters having different prices.

38. The interactive display system of claim 36, wherein the kiosk spends interactive display devices with characters having at least one of character image, character attributes, and personalization data determined at least in part based upon a price paid for the interactive display devices.

39. The interactive display system of claim 29, wherein the interactive display devices take the form of tradeable cards.

40. A method for operating an interactive display device having interaction data stored therein, the method comprising the steps of:
detecting another interactive display device having interaction data stored therein;
receiving interaction data from the other interactive display device;
determining modified interaction data based at least in part upon the interaction data received from the other interactive display device;
determining a character image based at least in part upon the modified interaction data; and
presenting the character image using the display device, and storing the modified interaction data in the interactive display device.

41. The method of claim 40, further comprising the step of transmitting the interaction data to the other display device.

42. The method of claim 40, wherein the interaction data comprises a status score and the step of generating modified interaction data comprises adjusting the status score, and further comprising the step of prohibiting further interaction between the interactive display device and other interactive display devices, when the status score falls below a threshold.

43. The method of claim 42, further comprising the step of generating a reset signal that adjust the status score above the threshold so as to remove the prohibition on further interaction between the interactive display device another interactive display device.
